(19) United States
(12) Patent Application Publication
(10) Pub. No.: US 2025/0295224 A1
(43) Pub. Date: Sep. 25, 2025

(54) SELF-CONDITIONING CLEANIG BRUSH SYSTEM

(71) Applicant: SAMSUNG ELECTRONICS CO., LTD., Suwon-si (KR)

(72) Inventors: Jihee YANG, Suwon-si (KR); Donghoon KWON, Suwon-si (KR)

(73) Assignee: SAMSUNG ELECTRONICS CO., LTD., Suwon-si (KR)

(21) Appl. No.: 18/906,932

(22) Filed: Oct. 4, 2024

(30) Foreign Application Priority Data
Mar. 19, 2024 (KR) 10-2024-0037914

(51) Int. Cl. A46B 9/00; A46B 13/00

(52) U.S. Cl. CPC A46B 9/005; A46B 13/001; A46B 2200/30

(57) ABSTRACT

A cleaning brush system includes a cleaning brush including a cylindrical body including a first end and a second end opposite to the first end and at least one cleaning protrusion protruding from the cylindrical body, where a surface of the cylindrical body includes a first composition including a first copolymer, and a surface of the at least one cleaning protrusion includes a second composition including a second copolymer.

### CROSS-REFERENCE TO RELATED APPLICATION

This application is based on and claims priority under 35 U.S.C. § 119 to Korean Patent Application No. 10-2024-0037914, filed on May 19, 2024, in the Korean Intellectual Property Office, the disclosure of which is incorporated by reference herein in its entirety.

### BACKGROUND

Example embodiments of the disclosure relate to a self-conditioning cleaning brush system.

The importance of cleaning process technology for an ultra-clean surface has continuously increased as the density and intensity of semiconductor devices increases.

In terms of semiconductor yield and reliability, as ultra-clean surfaces may be required. Thus, the importance of a cleaning process to remove contaminants continues to increase, and the cleaning process is no longer just a simple operation or process, but is emerging as a core process in semiconductor manufacturing.

In particular, after a chemical mechanical polishing (CMP) process, which generates relatively many contaminants by polishing a surface using slurry, to more efficiently remove remaining abrasive particles and polishing by-products, brush scrubbing process technology may be mainly used in a cleaning up process referred to as post-CMP. The brush scrubbing process technology may be a physical cleaning method that uses a brush made of polyvinyl alcohol (PVA) material to make direct contact with a wafer surface.

Contaminants generated during a semiconductor process may require removal as the contaminants have a significant impact on the performance, reliability, and yield of a device by distorting the structural shape and deteriorating the electrical characteristics of the device. In the case of a nanometer-level device process (i.e., due to advancements in miniaturization technology), the range of allowable particle sizes is drastically reduced, and the presence of contaminants has a detrimental impact on device yield.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a cleaning brush system capable of improving reliability by preventing reverse contamination.

Additional aspects will be set forth in part in the description which follows and, in part, will be apparent from the description, or may be learned by practice of the presented embodiments.

According to an aspect of an example embodiment, a cleaning brush system may include a cleaning brush including a cylindrical body including a first end and a second end opposite to the first end and at least one cleaning protrusion protruding from the cylindrical body, where a surface of the cylindrical body includes a first composition including a first copolymer, and a surface of the at least one cleaning protrusion includes a second composition including a second copolymer.

According to an aspect of an example embodiment, a cleaning brush system may include a cleaning brush including a cylindrical body extending in a first direction and at least one cleaning protrusion protruding from the cylindrical body, and a cleaning brush conditioner configured to rotate, where a surface of the cleaning brush includes a first composition including a first copolymer and a second composition including a second copolymer, and the first copolymer includes a hydrophobic copolymer and the second copolymer includes a hydrophilic copolymer.

According to an aspect of an example embodiment, a cleaning brush system may include a cleaning brush including a cylindrical body and at least one cleaning protrusion protruding from the cylindrical body, and a cleaning brush conditioner arranged in parallel with the cylindrical body of the cleaning brush, where a surface of the cleaning brush includes a first composition including a first copolymer, and a second composition including a second copolymer, and the first copolymer includes a hydrophobic copolymer and the second copolymer includes a hydrophilic copolymer.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a diagram illustrating a cleaning brush and a substrate, according to one or more embodiments;

FIG. 2 is a perspective view illustrating the cleaning brush of FIG. 1 according to one or more embodiments;

FIG. 3 is a front view illustrating the cleaning brush of FIG. 1 according to one or more embodiments;

FIG. 4 is a diagram illustrating a surface of the cleaning brush of FIG. 1 according to one or more embodiments;

FIGS. 5 to 8 are enlarged views illustrating examples correspond to portion EX of FIG. 4;

FIGS. 9A to 9D are diagrams illustrating operations of a cleaning brush and a cleaning brush conditioner, according to one or more embodiments; and

FIGS. 10 to 15 are diagrams illustrating cleaning brushes and cleaning brush conditioners, according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

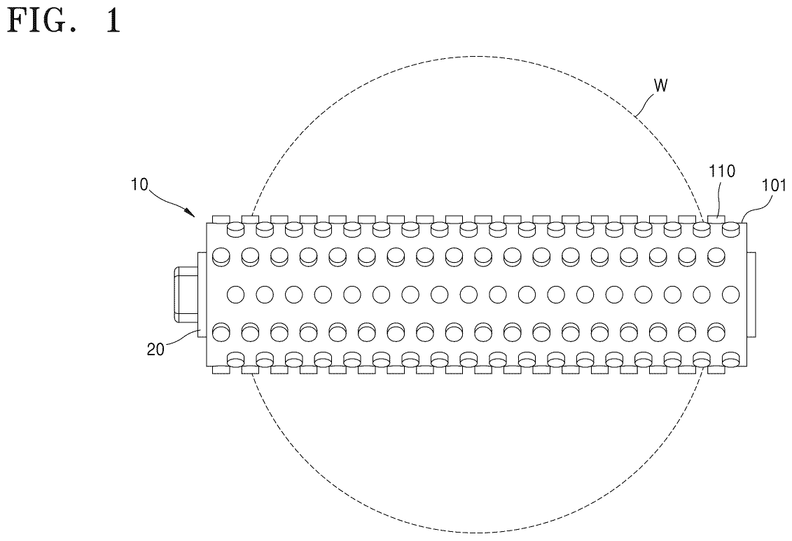

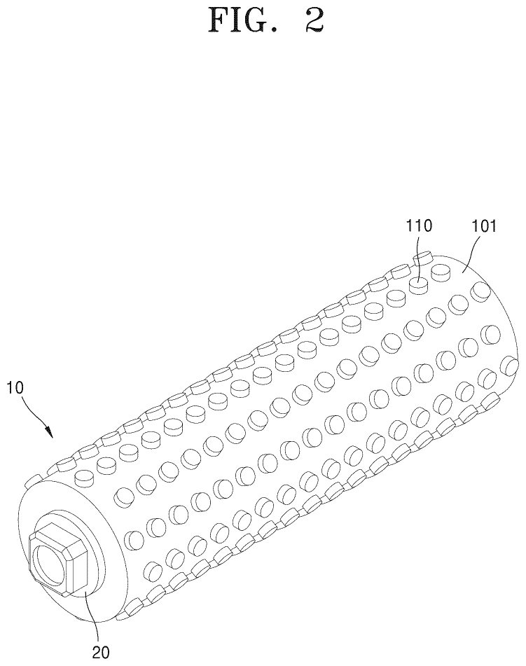

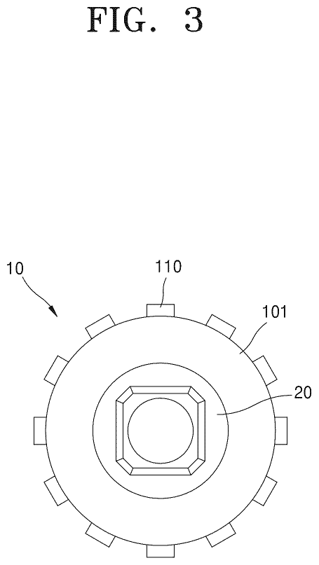

FIG. 1 is a diagram illustrating a cleaning brush 10 and a substrate W, according to one or more embodiments. FIG. 2 is a perspective view illustrating the cleaning brush 10 of FIG. 1 according to one or more embodiments. FIG. 3 is a front view illustrating the cleaning brush 10 of FIG. 1 according to one or more embodiments.

Referring to FIGS. 1 to 3, the cleaning brush 10 may include a cylindrical body 101 and a plurality of cleaning protrusions (a single cleaning protrusion 110 is identified and described for ease of description). The cylindrical body 101 may include a first end and a second end opposite to the first end. The cleaning brush 10 may include poly-vinyl acetate (PVA). The cleaning brush 10 may rotate about a rotation axis connecting the centers of the ends of the cylindrical body 101. The cleaning brush 10 may be mounted on a brush core or mandrel 20 for rotating the cleaning brush 10 about the rotation axis.

According to one or more embodiments, the cleaning brush 10 may be configured to clean a surface of the substrate W. According to one or more embodiments, the cleaning brush 10 may be configured to perform chemical mechanical polishing (CMP) on the surface of the substrate W. CMP may refer to a technology that flattens the substrate W through chemical polishing based on a surface chemical action of an abrasive itself and/or a chemical action of a slurry and mechanical polishing through relative movement of the slurry and the substrate W.

The substrate W may be a substrate on which various processes are performed. The substrate W may include, for example, silicon (SI). The substrate W may include a semiconductor material such as germanium (Ge), or a compound semiconductor material such as silicon carbide (SiC), gallium arsenide (GaAs), indium arsenide (InAs), and indium phosphide (InP). Here, a diameter of the substrate W may be about 300 mm, but is not limited thereto. A diameter of the substrate W may be, for example, about 150 mm, about 200 mm, or about 450 mm, or may be larger.

The substrate W may be used to manufacture a memory device, such as a volatile memory device, a non-memory device, etc. According to one or more embodiments, the memory device may be non-volatile NAND-type flash memory. According to one embodiments, the memory device may include a random access memory (RAM), a phase-change RAM (PRAM), magnetoresistive RAM (MRAM), resistive RAM (ReRAM), ferroelectric RAM (FRAM), or NOR flash memory. The memory device may be a volatile memory device such as dynamic (DRAM) and static RAM (SRAM), in which data is lost when power is turned off. According to one or more embodiments, the memory device may be a logic chip, a measurement device, a communication device, a digital signal processor (DSP), or a system-on-chip (SOC).

According to one or more embodiments, the substrate W may be a substrate on which a series of semiconductor device manufacturing processes are completed. According to one or more embodiments, the substrate W may be a substrate used just before an assembly process that includes dicing and packaging, but embodiments are not limited thereto. For example, after the substrate W is cleaned by a wafer cleaning device, such as a cleaning brush 10, an additional semiconductor device manufacturing process, such as chemical vapor deposition (CVD), atomic layer deposition (ALD), or lithography may be performed on the substrate W.

Particles may remain on the surface of the substrate W. When particles with a diameter larger than a gap between wires formed on the surface remain, a short circuit may occur. The particles and the surface of the substrate W may be relatively weakly bonded. Accordingly, particles on the surface of the substrate W may be removed by providing a cleaning solution and distilled water on the surface of the substrate W and wiping the surface with the cleaning brush 10.

The plurality of cleaning protrusions 110 may be arranged along a surface of the cylindrical body 101 between the first end and the second end of the cylindrical body 101. The cleaning protrusions 110 may be arranged regularly at regular intervals along the cylindrical body 101. However, embodiments are not limited thereto, and the cleaning protrusions 110 may be arranged irregularly on the cylindrical body 101.

The cleaning protrusion 110 is shown as having a circular cross-section perpendicular to a direction in which the cleaning protrusions 110 are arranged, but embodiments are not limited thereto, and the shape may be formed in various shapes such as oval or square.

The cleaning protrusion 110 may contact the substrate W during a cleaning process. The cylindrical body 101 and the cleaning protrusion 110 formed on the cylindrical body 101 may include two or more different types of repeating units, as will be described later, and more specifically, two or more types of copolymers. In this case, the two or more types of copolymers may include at least one type of hydrophilic copolymer and at least one type of hydrophobic copolymer. Example embodiments are described herein as implementing copolymers, but the embodiments are not limited thereto, as polymers and other polymer-based compositions may be implemented without departing from the scope of the embodiments as will be understood by one of ordinary skill in the art from the disclosure herein.

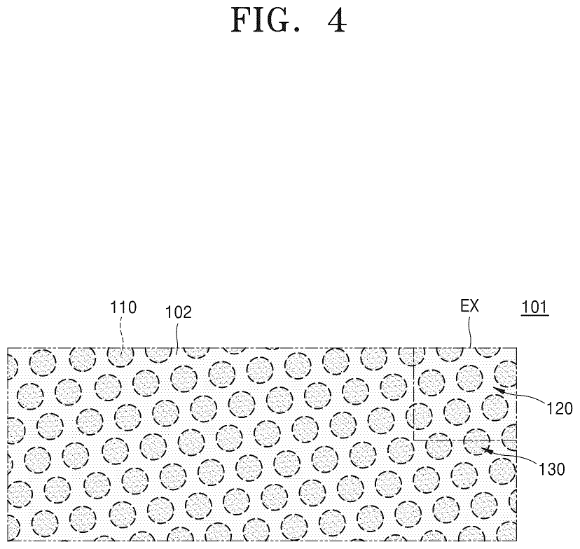

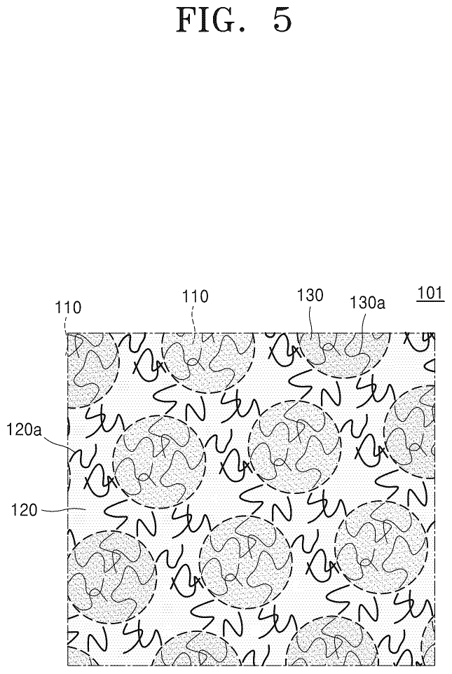

FIG. 4 is a diagram illustrating a surface of the cylindrical body 101 of the cleaning brush 10 of FIG. 1 according to one or more embodiments, and FIG. 5 is an enlarged diagram of a portion EX of FIG. 4 according to one or more embodiments.

Referring to FIGS. 4 and 5 together, on the cylindrical body 101 a first composition 120 and a second composition 130 may be mixed. That is, the surface 102 of the cylindrical body 101 that is between the cleaning protrusions 110 may include a first composition 120, and the surfaces of the cleaning protrusions 110 may include the second composition 130. In one or more embodiments, the first composition 120 and the second composition 130 may be include copolymers having different compositions.

A plurality of first copolymers 120a may be provided in the first composition 120. A plurality of second copolymers 130a may be provided in the second composition 130.

The first composition 120 may include a hydrophobic copolymer, and the second composition 130 may include a hydrophilic copolymer. That is, the first copolymer 120a may include a hydrophobic copolymer, and the second copolymer 130a may include a hydrophilic copolymer.

In one or more embodiments, the first composition 120 may include PVA. In one or more embodiments, the second composition 130 may be a set of chelator polymers having a carboxyl group (—COOH) functional group. For example, the second composition 130 may include Ce chelator polymer and/or Ti chelator polymer, but embodiments are not limited thereto.

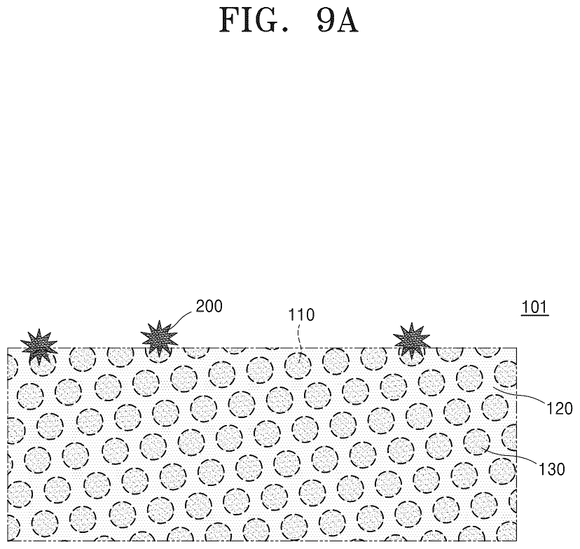

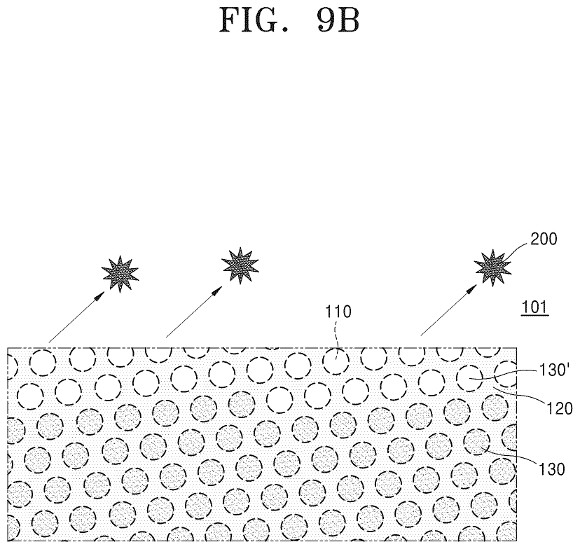

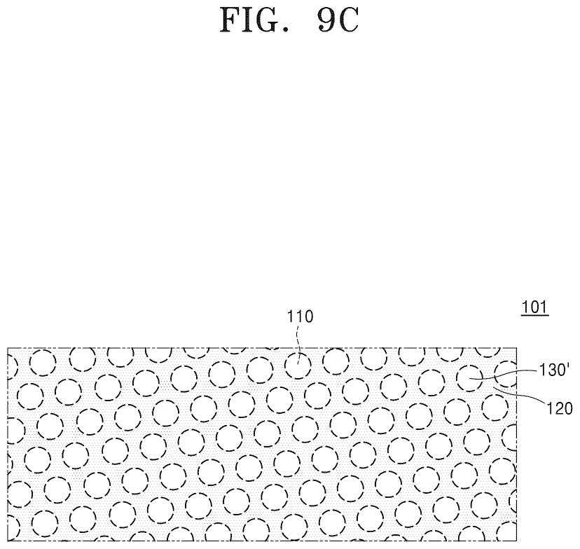

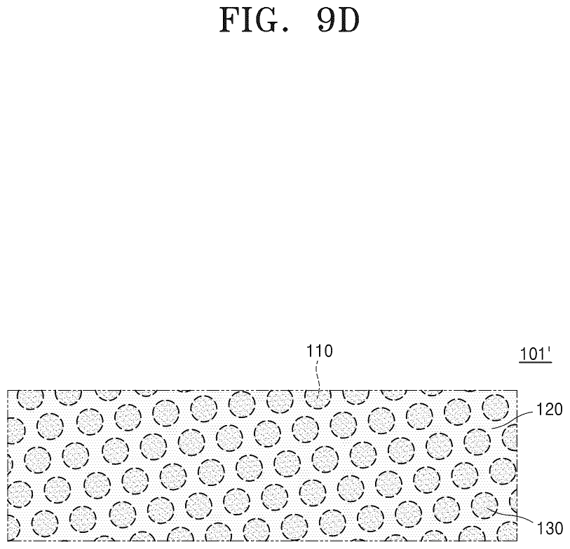

As described later with reference to FIGS. 9A to 9D, the second copolymer 130a provided in the second composition 130 may perform a self-conditioning function of the cleaning brush 10 while dissolving in water later.

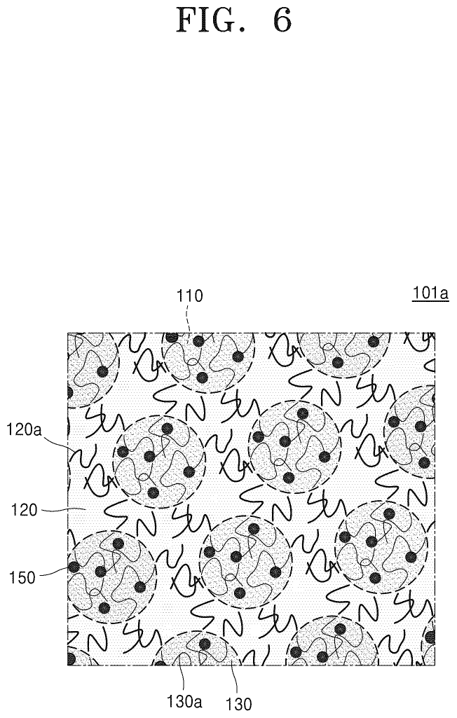

FIG. 6 is an enlarged diagram illustrating an example of portion EX of FIG. 4 according to one or more embodiments. In particular, FIG. 6 is a diagram of a surface of a cylindrical body 101a of a cleaning brush 10 according to one or more embodiments. Description of aspects that are the same or similar as those described above may be omitted.

Referring to FIG. 6, the cylindrical body 101a may further include a monomolecular additive 150 in addition to the first composition 120 and the second composition 130. The monomolecular additive 150 may be added to the surfaces of the cleaning protrusions 110, but embodiments are not limited thereto.

In this case, the monomolecular additive 150 may have hydrophilic properties, and thus may have affinity with the second copolymer 130a provided in the second composition 130. That is, the monomolecular additive 150 may be disposed on the second composition 130.

In FIGS. 5 and 6, the second composition 130 is shown as being located between the first compositions 120 and formed in a circular pattern at regular intervals, but embodiments are not limited thereto and heterogeneous shapes may be irregularly arranged or may be arranged in a pattern other than circular.

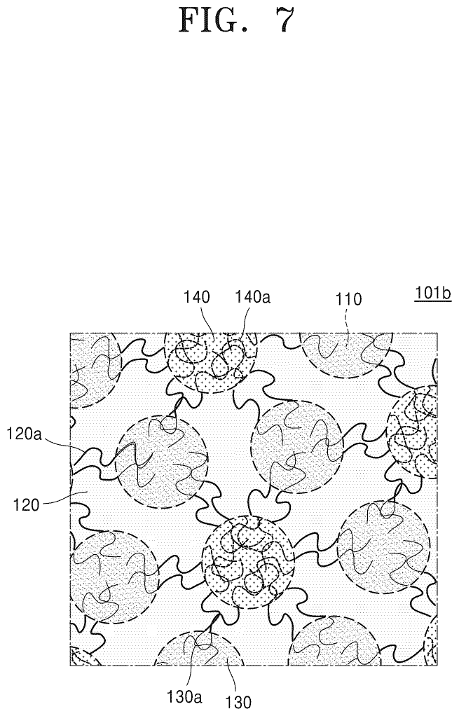

FIG. 7 is an enlarged view illustrating an example of portion EX of FIG. 4, according to one or more embodiments. That is, FIG. 7 is an enlarged diagram of a surface of a cylindrical body 101b of the cleaning brush 10 according to one or more embodiments. Description of aspects that are the same or similar as those described above may be omitted.

Referring to FIG. 7, the cylindrical body 101b may include the first composition 120, the second composition 130, and a third composition 140.

A plurality of third copolymers 140a may be provided in the third composition 140. In this case, the plurality of third copolymers 140a may include a hydrophilic copolymer having a different composition from the plurality of second copolymers 130a provided in the second composition 130. The third composition 140 may be provided on the surface of the cleaning protrusions 110.

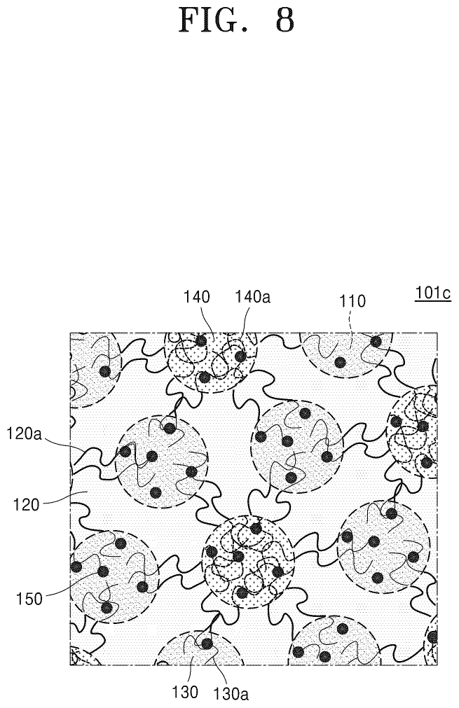

FIG. 8 is an enlarged view illustrating an example of portion EX of FIG. 4, according to one or more embodiments. That is, FIG. 8 is an enlarged diagram of a surface of a cylindrical body 101c of the cleaning brush 10 according to one or more embodiments. Description of aspects that are the same or similar as those described above may be omitted.

Referring to FIG. 8, the surface of the cylindrical body 101c may include the first composition 120, the second composition 130, and the third composition 140, and may further include monomolecular additive 150.

The monomolecular additive 150 of FIG. 8 may have hydrophilic properties similar to the monomolecular additive shown in FIG. 6, and thus may have affinity with the second copolymer 130a provided in the second composition 130 and the third copolymer 140a provided in the third composition 140. That is, the monomolecular additive 150 may be disposed on the second composition 130 and/or the third composition 140.

FIGS. 7 and 8 are shown to include the first composition 120, the second composition 130, and the third composition 140, but embodiments are not limited thereto and hydrophilic compositions with different compositions may be further located.

FIGS. 5 and 6 show a case in which the first composition 120 is on the surface of the cylindrical body 101 between the cleaning protrusions 110, and the second composition 130 are on surfaces of the protrusions. FIGS. 7 and 8 show a case in which the first composition 120 are on the surface of the cylindrical body 101 between the cleaning protrusions 110, while the second composition 130, and the third composition 140 are on surfaces of the cleaning protrusions 110. However, embodiments are not limited thereto, the copolymers may be randomly mixed without being distinguished from each other. For example, the first composition 120, the second composition 130, the third composition 140, and the monomolecular additives 150 may be formed on the surface of the cylindrical body 101 between the cleaning protrusions 110, on the surface of the cleaning protrusions 110, or any combination thereof as will be understood by one of ordinary skill in the art from the disclosure herein.

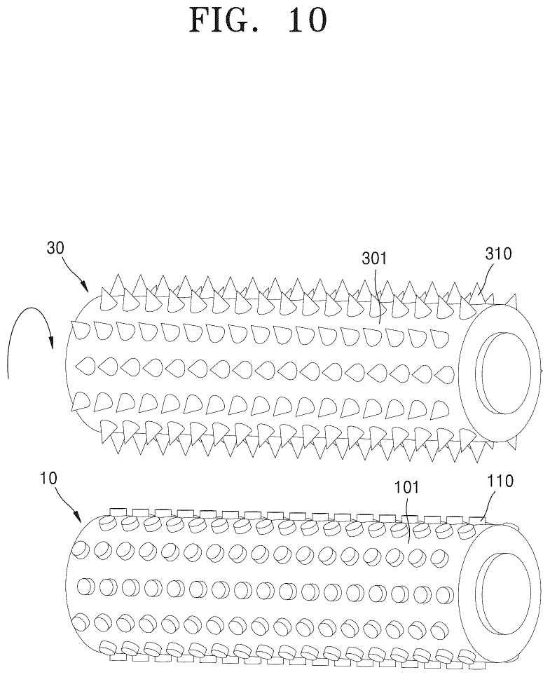

FIGS. 9A to 9D are diagrams illustrating operations of the cleaning brush 10 (FIGS. 10 to 15) and a cleaning brush conditioner 30 (FIGS. 10 to 15), according to one or more embodiments.

Referring to FIG. 9A, contaminants 200 from the surface of the substrate W (refer to FIG. 1) may be adsorbed by the surface of the cylindrical body 101 and/or the surface of the cleaning protrusions 110 of the cleaning brush 10 (refer to FIG. 1) by way of the compositions (e.g., 120, 130, 140, etc.). The contaminants 200 may be particularly adsorbed by the second composition 130. Alternatively, as shown in FIGS. 7 and 8, when a hydrophilic composition including a hydrophilic copolymer is further provided in addition to the second composition 130, the contaminants 200 may also be adsorbed on the hydrophilic composition. In FIGS. 9A to 9D, for convenience of explanation, all hydrophilic compositions to be provided on the surface of the cylindrical body 101 are referred to as second compositions 130.

Referring to FIGS. 9B and 9C together, as the hydrophilic copolymer provided in the second composition 130 is removed (e.g., melts) due to the use of the cleaning brush conditioner 30, the contaminants 200 may be removed as well. As a result, a portion of the second composition 130 may also be removed and remain as an empty area 130′. That is, the hydrophilic composition from the cleaning protrusions 110 (as well as from the surface of the cylindrical body 101 between the cleaning protrusions 110 in some examples) may be removed along with the contaminants 200 by way of the cleaning brush conditioner 30.

Referring to FIG. 9D, the second composition 130 (and other compositions) may be added to an area 130′ in which the composition was removed by the cleaning brush conditioner 30, and compositions may be newly applied to the cylindrical body 101′. As the cleaning brush 10 (refer to FIG. 1) cleans the surface of the substrate W (refer to FIG. 1), new contaminants may be adsorbed again on the surface of the cylindrical body 101′, and accordingly, self-conditioning of the cleaning brush 10 (refer to FIG. 1) may be repeatedly performed.

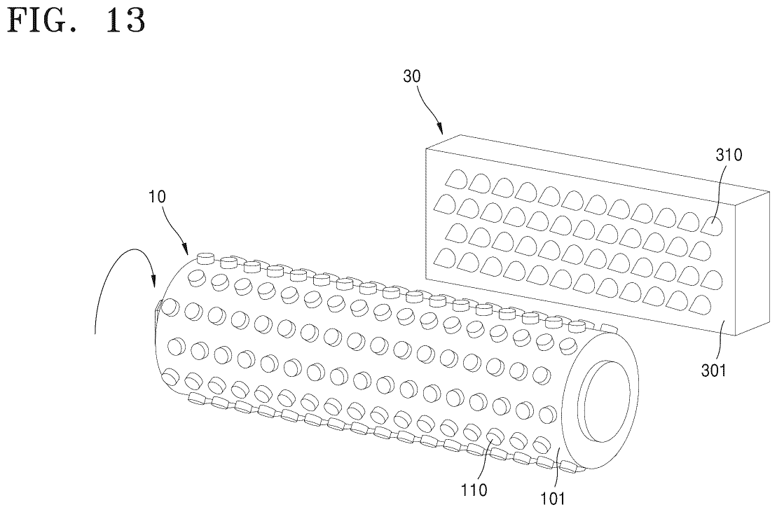

FIGS. 10 to 15 are diagrams illustrating cleaning brushes and cleaning brush conditioners, according to one or more embodiments. In detail, FIGS. 10 to 12 illustrate one or more embodiments in which the cleaning brush conditioner 30 rotates and/or moves, and FIGS. 13 to 15 illustrate one or more embodiments in which the cleaning brush conditioner 30 is fixed.

Referring to FIG. 10, the cleaning brush conditioner 30 may rotate on the cleaning brush 10, and a conditioner protrusion 310 attached to a cylindrical body 301 of the cleaning brush conditioner 30 may clean the surface of the cylindrical body 101 of the cleaning brush 10. Although FIG. 10 shows the cleaning brush conditioner 30 rotating clockwise, embodiments are not limited thereto and the cleaning brush conditioner 30 may also rotate counterclockwise.

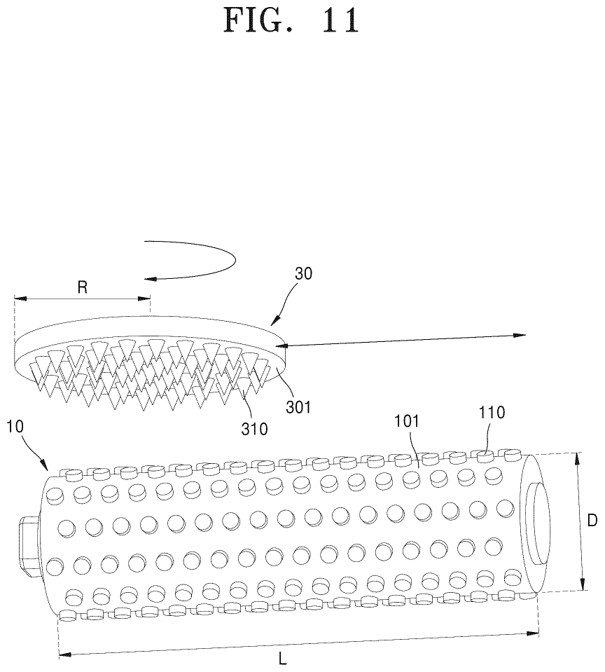

Referring to FIG. 11, the cleaning brush conditioner 30 may rotate on the cleaning brush 10 and simultaneously move in a direction in which the cleaning brush 10 extends. That is, the cleaning brush conditioner 30 may perform a rotational operation and a moving operation simultaneously. In this case, although FIG. 11 shows the cleaning brush conditioner 30 rotating clockwise, embodiments are not limited thereto and the cleaning brush conditioner 30 may also rotate counterclockwise on the cleaning brush 10.

A vertical width D of the cleaning brush 10 may be less than the length of a horizontal width L of the cleaning brush 10.

In one or more embodiments, a radius R of a horizontal cross-section of the cleaning brush conditioner 30 may be larger than the vertical width D of the cleaning brush 10. In one or more embodiments, the radius R of the horizontal cross-section of the cleaning brush conditioner 30 may range from about 20% to about 50% of the horizontal width L of the cleaning brush 10, but embodiments are not limited thereto.

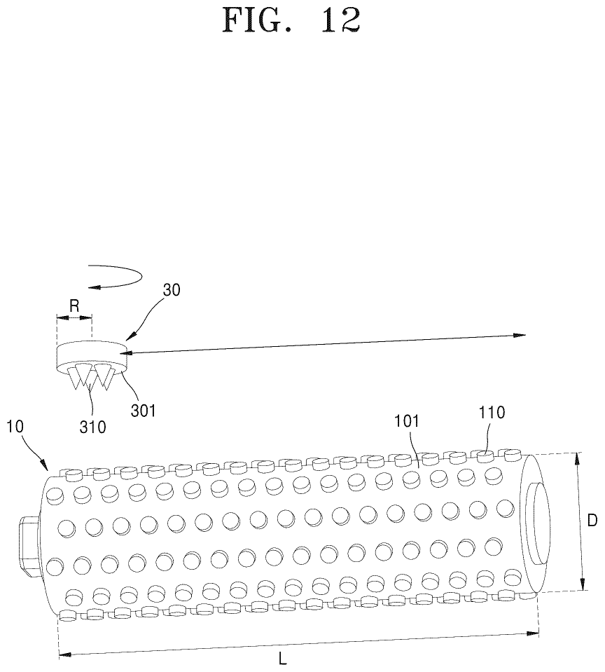

Referring to FIG. 12, similar to FIG. 11, the cleaning brush conditioner 30 may simultaneously perform a rotational operation and a moving operation on the cleaning brush 10. The cleaning brush conditioner 30 is shown to rotate clockwise, but embodiments are not limited thereto, and the cleaning brush conditioner 30 may also rotate counterclockwise on the cleaning brush 10.

In one or more embodiments, the vertical width D of the cleaning brush 10 may be less than the horizontal width L of the cleaning brush 10.

In one or more embodiments, a radius R of a horizontal cross-section of the cleaning brush conditioner 30 may be less than the vertical width D of the cleaning brush 10. In one or more embodiments, the radius R of the horizontal cross-section of the cleaning brush conditioner 30 may range from about 1% to about 20% of the horizontal width L of the cleaning brush 10, but embodiments are not limited thereto.

Referring to FIG. 13, the cleaning brush conditioner 30 may be fixed in a position parallel to the cylindrical body 101 of the cleaning brush 10. As the cleaning brush 10 rotates independently, the conditioner protrusion 310 attached to the cleaning brush conditioner 30 may come into contact with the cylindrical body 101 of the cleaning brush 10 and clean the surface of the cleaning brush 10. In FIG. 13, the cleaning brush 10 is shown to rotate clockwise, but the cleaning brush 10 may also rotate counterclockwise.

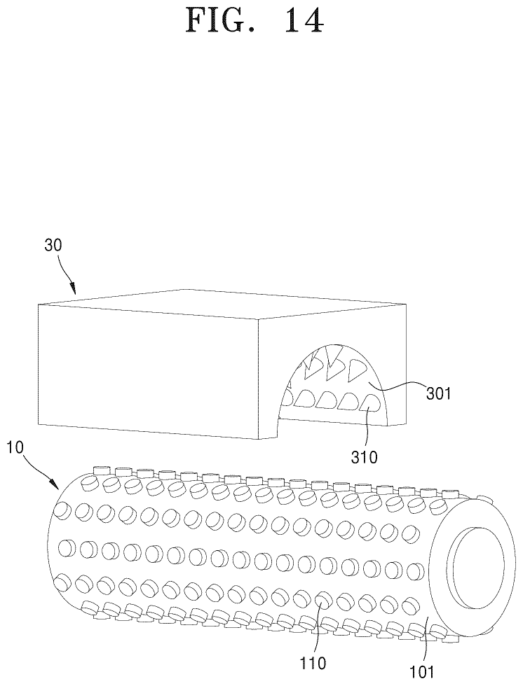

Referring to FIG. 14, the cleaning brush conditioner 30 may be formed in a tunnel-type structure with a concave groove. Conditioner protrusions 310 may be located in the concave groove of the cleaning brush conditioner 30, and as the cleaning brush 10 rotates clockwise or counterclockwise, the cleaning brush 10 may be in physical contact with the conditioner protrusions 310 located in the concave groove of the cleaning brush conditioner 30 to clean the surface of the cylindrical body 101.

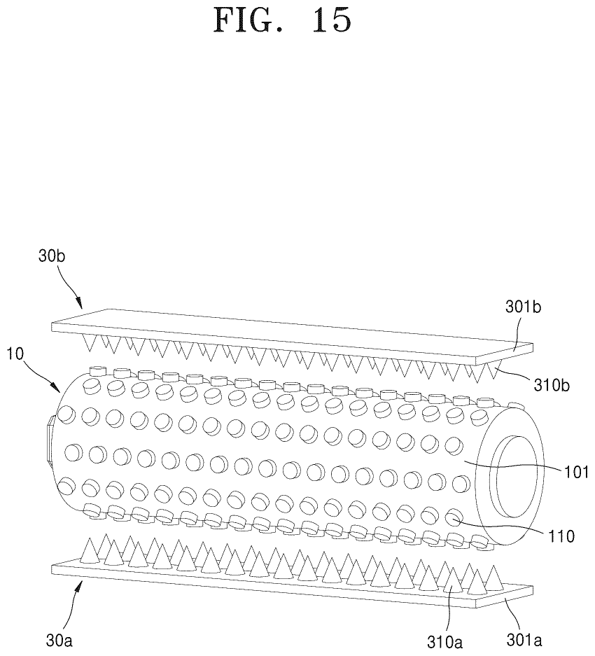

Referring to FIG. 15, the cleaning brush conditioner 30 may include a first cleaning brush conditioner 30a and a second cleaning brush conditioner 30b, and the first and second cleaning brush conditioners 30a and 30b may be spaced apart from each other in parallel with the cleaning brush 10 therebetween. That is, the cleaning brush 10 may be located between the first cleaning brush conditioner 30a and the second cleaning brush conditioner 30b.

A conditioner protrusion 310a may be disposed on a surface 301a of the first cleaning brush conditioner 30a, which faces the cleaning brush 10. A conditioner protrusion 310b may be disposed on a surface 301b of the second cleaning brush conditioner 30b, which faces the cleaning brush 10. The cleaning brush 10 may rotate between the first cleaning brush conditioner 30a and the second cleaning brush conditioner 30b and may be in contact with the conditioner protrusions 310a and 310b to clean the surface of the cylindrical body 101.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A cleaning brush system comprising:
a cleaning brush comprising:
a cylindrical body comprising a first end and a second end opposite to the first end; and
at least one cleaning protrusion protruding from the cylindrical body,
wherein a surface of the cylindrical body comprises a first composition comprising a first copolymer, and
wherein a surface of the at least one cleaning protrusion comprises a second composition comprising a second copolymer.

2. The cleaning brush system of claim 1, wherein the first copolymer comprises a hydrophobic copolymer and the second copolymer comprises a hydrophilic copolymer.

3. The cleaning brush system of claim 2, wherein the first composition comprises poly-vinyl acetate (PVA), and the second composition comprises a chelator polymer having a carboxyl group (—COOH) functional group.

4. The cleaning brush system of claim 1, further comprising a monomolecular additive on the second composition,
wherein the monomolecular additive has hydrophilic properties.

5. The cleaning brush system of claim 1, wherein the cleaning brush further comprises a hydrophilic copolymer that is different from a material of the first composition and the second composition.

6. The cleaning brush system of claim 1, further comprising a cleaning brush conditioner comprising a cylindrical body and at least one conditioner protrusion protruding from the cylindrical body of the cleaning brush conditioner,
wherein the cleaning brush conditioner is configured to rotate clockwise or counterclockwise such that the conditioner protrusion contacts the cylindrical body of the cleaning brush.

7. The cleaning brush system of claim 1, further comprising a cleaning brush conditioner having a disk shape and having one surface facing the cleaning brush and comprising at least one conditioner protrusion on the one surface,
wherein the cleaning brush conditioner is configured to simultaneously move in a first direction in which the cleaning brush extends and rotate clockwise or counterclockwise such that the at least one conditioner protrusion contacts the cylindrical body of the cleaning brush.

8. The cleaning brush system of claim 7, wherein a radius of a horizontal cross-section of the cleaning brush conditioner is larger than a diameter of a vertical cross-section of the cleaning brush, and
wherein the radius of the horizontal cross-section of the cleaning brush conditioner is in a range of 20% to 50% of a length of the cleaning brush in the first direction.

9. The cleaning brush system of claim 7, wherein a radius of a horizontal cross-section of the cleaning brush conditioner is less than a diameter of a vertical cross-section of the cleaning brush, and
wherein the radius of the horizontal cross-section of the cleaning brush conditioner is in a range of 1% to 20% of a length of the cleaning brush in the first direction.

10. The cleaning brush system of claim 1, further comprising a cleaning brush conditioner fixed to one side surface of the cleaning brush and having one surface facing the cleaning brush, the cleaning brush conditioner comprising at least one conditioner protrusion on the one surface,
wherein the at least one conditioner protrusion is configured to contact the cylindrical body of the cleaning brush as the cleaning brush rotates.

11. A cleaning brush system comprising:
a cleaning brush comprising a cylindrical body extending in a first direction and at least one cleaning protrusion protruding from the cylindrical body; and
a cleaning brush conditioner configured to rotate,
wherein a surface of the cleaning brush comprises a first composition comprising a first copolymer and a second composition comprising a second copolymer, and
wherein the first copolymer comprises a hydrophobic copolymer and the second copolymer comprises a hydrophilic copolymer.

12. The cleaning brush system of claim 11, wherein the cleaning brush conditioner comprises a cylindrical body and at least one conditioner protrusion protruding from the cylindrical body of the cleaning brush conditioner, and
wherein the cylindrical body of the cleaning brush and the cylindrical body of the cleaning brush conditioner are parallel in the first direction.

13. The cleaning brush system of claim 11, wherein the cleaning brush conditioner has a disk shape having one surface facing the cleaning brush,
wherein the cleaning brush conditioner comprises at least one conditioner protrusion on the one surface,
wherein a radius of a horizontal cross-section of the cleaning brush conditioner is larger than a diameter of a vertical cross-section of the cleaning brush, and
wherein the radius of the horizontal cross-section of the cleaning brush conditioner is in a range of 20% to 50% of a length of the cleaning brush in the first direction.

14. The cleaning brush system of claim 11, wherein the cleaning brush conditioner has a disk shape having one surface facing the cleaning brush,
wherein the cleaning brush conditioner comprises at least one conditioner protrusion on the one surface,
wherein a radius of a horizontal cross-section of the cleaning brush conditioner is less than a diameter of a vertical cross-section of the cleaning brush, and
wherein the radius of the horizontal cross-section of the cleaning brush conditioner is in a range of 1% to 20% of a length of the cleaning brush in the first direction.

15. The cleaning brush system of claim 11, further comprising a hydrophilic monomolecular additive on the second composition.

16. A cleaning brush system comprising:
a cleaning brush comprising a cylindrical body and at least one cleaning protrusion protruding from the cylindrical body; and
a cleaning brush conditioner arranged in parallel with the cylindrical body of the cleaning brush,
wherein a surface of the cleaning brush comprises a first composition comprising a first copolymer, and a second composition comprising a second copolymer, and
wherein the first copolymer comprises a hydrophobic copolymer and the second copolymer comprises a hydrophilic copolymer.

17. The cleaning brush system of claim 16, wherein the cleaning brush conditioner has a plate-shaped shape having one surface facing the cleaning brush, and
wherein the cleaning brush conditioner comprises at least one conditioner protrusion on the one surface, and configured to contact the cylindrical body of the cleaning brush.

18. The cleaning brush system of claim 16, wherein the cleaning brush conditioner has one surface on which at least one conditioner protrusion is located, and has a tunnel shape with a concave groove in the one surface, and
wherein the concave groove is configured to contact the cylindrical body of the cleaning brush.

19. The cleaning brush system of claim 16, wherein the cleaning brush conditioner comprises a first cleaning brush conditioner and a second cleaning brush conditioner parallel to each other and spaced apart from each other,
wherein each of the first cleaning brush conditioner and the second cleaning brush conditioner have a plate shape having one surface facing the cleaning brush, and at least one conditioner protrusion on the one surface, and
wherein the cleaning brush is between the first cleaning brush conditioner and the second cleaning brush conditioner.

20. The cleaning brush system of claim 16, further comprising a hydrophilic monomolecular additive on the second composition.
